(19) United States
(12) Patent Application Publication
(10) Pub. No.: US 2007/0026812 A1
(43) Pub. Date: Feb. 1, 2007

(54) Power level control for RF transmitters

(75) Inventors: Zhiqun Hu, Liberty Township, OH (US); Paul Henry Mizwicki, Warren, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Harris Corporation

(21) Appl. No.: 11/190,332

(22) Filed: Jul. 27, 2005

(51) Int. Cl. H04B 1/00

(52) U.S. Cl. 455/69

(57) ABSTRACT

A digital power level control is presented for an RF broadcast transmitter. This control includes an RF high power amplifier that receives an RF signal from an exciter and provides therefrom an amplified RF output. An adjustable attenuator is interposed between the exciter and the power amplifier for adjusting the level of the RF signal. An RF controller adjusts the attenuator. A high power amplifier controller controls the high power amplifier. A communication bus interconnects the controller.

### BACKGROUND OF THE INVENTION

1. Technical Field

The present invention is directed to the art of RF power amplifier systems suitable for use in RF broadcast transmission systems and, more particularly, to improvements in the power level control thereof.

2. Description of the Prior Art

RF power amplifiers are known in the art. They are used in radio and television broadcast applications. Typically, they employ control schemes for RF signal amplification. The ALC (Automatic Level Control) or APC (Automatic Power Control), and AGC (Automatic Gain Control) closed-loop control schemes are widely used in RF signal amplification. These closed-loops are constructed with a signal source (such as exciter), a gain control device (such as RF attenuator), an RF driver device (such as an intermediate power amplifier IPA), a power amplification device (such as an RF power transmitter or a single RF power amplifier), input and output RF sensors, and a controller. A control signal generated by the controller based on a control algorithm is applied to the attenuator, which adjusts the gain of the overall RF system and ultimately it adjusts the transmitter output power, or transmitter forward power. The ALC/APC/AGC schemes will try to maintain the RF transmitter output power constant under the conditions of temperature variation and supply voltage variation, which cause gain change in the RF chain and external interferences to the transmitter system. During normal operation, the reference and output power are in equilibration, thus the control voltage, which controls the system gain, will stay at a relatively stable value and maintain the output power as a constant.

Issues

The ordinary ALC scheme uses operational amplifiers to build the power control system. These hardware based ALC schemes have some limitations and issues. And they include:

1. In practical situation, these RF transmitters, especially high power ones, will have large physical dimensions. The controller, the controlled device and the attenuator could be located in different locations and separated by some distance. Frequently, they are located in separate cabinets, called driver cabinet and power amplifier cabinet and these cabinets could be separated by more than 30 feet, for example. Traditionally, the ALC loop is implemented in an analog circuit, thus the control signal to the attenuator could be vulnerable to EMI noise due to the long distance at the RF environment. This directly affects the output power accuracy of the transmitter. To overcome the noise issue, an extra filter for the control signal may be used.

2. With an analog ALC, it is hard to meet most of these requirements and the transmitter may be vulnerable to some unpredicted conditions, such as power overdrive or power overload. One of the most common cases is power overdrive and power overload due to sudden drive power loss. During normal operation, a sudden interruption of the drive power (such as there is some fault in the IPA) may cause it to go through a fault process. During an IPA fault recovering process, the drive power may lose for a certain period of time, such as a few seconds. The drive power loss causes output power decreases and the ordinary ALC or APC controller tends to increase the values of the control signal in order to gain back the output power. The control voltage could reach and maintain the maximum value for minimum attenuation, which will deliver the highest gain in the gain control device. This will continue until the IPA recovers from a temporary fault and starts to deliver the drive power. Since the control signal reaches the maximum, if the drive power comes back it will cause a huge output power increase which will cause either a power overload or drive overload. The overload could cause some damage in the system. A similar issue is that, since the drive power is proportional, as well as output power, to the control voltage, the drive power can only co-exist with the output power, if the IPA is faulted during power ramp up process and, the output power will stay at zero. The ordinary ALC will increase the control voltage to maximum to gain the power. Thus, if the IPA recovered from its fault, the maximum control voltage will cause output power overdrive and it may cause damage to the power amplifier.

3. The analog ALC lacks the flexible or sophisticated power ramping up procedure. There is no easy way to control the power ramping up slope and ramping up time, or the power ramp could not be changed or programmed according to the operation condition changing such as to make the ramping uptime constant while keeping the ramping up slope change for any power level.

4. For the multi-cabinet power amplification system, it is required that at the transmitter level and at the cabinet level it should have the ability to control the power rise or lower operation separately. The power of the transmitter, which is a summary of several cabinets, should be raised or lowered simultaneously, while the cabinet power should be raised or lowered at a remote mode or at a local mode. In either case the cabinet output power should have.a range from 0 to 100%. The ordinary ALC will not have the flexibility as it lacks the intelligence.

5. In some conditions, to tune the PID controller used in the ALC scheme, to satisfy the requirements for both the dynamic and steady state, it is difficult and challenging for an ordinary PID controller.

6. The transmitter requires having some kind of power reduction (called power foldback) mechanism at VSWR overload conditions, caused by RF system impedance mismatching. The digital ALC scheme could have flexibility to satisfy any kind of power reduction (power foldback) requirement, while the ordinary ALC circuit cannot meet. The power reduction or the power foldback could happen at transmitter level and power amplifier cabinet level. The ordinary ALC controller may only have transmitter level power foldback due to the complexity of the implementation for co-existence of transmitter foldback and cabinet foldback.

### SUMMARY OF THE INVENTION

In accordance with the present invention, a digital RF power amplifier system is provided for controlling the level of output RF power of the system. This includes an RF high power amplifier that receives an RF signal from an exciter and provides therefrom an amplified RF output. An adjustable attenuator is interposed between the exciter and the power amplifier for adjusting the level of the RF signal. An RF controller adjusts the attenuator. A high power amplifier controller controls the high power amplifier. A communication bus interconnects the controller.

### BRIEF DESCRIPTION OF THE DRAWIMGS

The foregoing and other advantages of the present invention will become more readily apparent to one skilled in the art to which the present invention relates upon consideration of the following description of the invention with reference to the accompanying drawings, wherein:

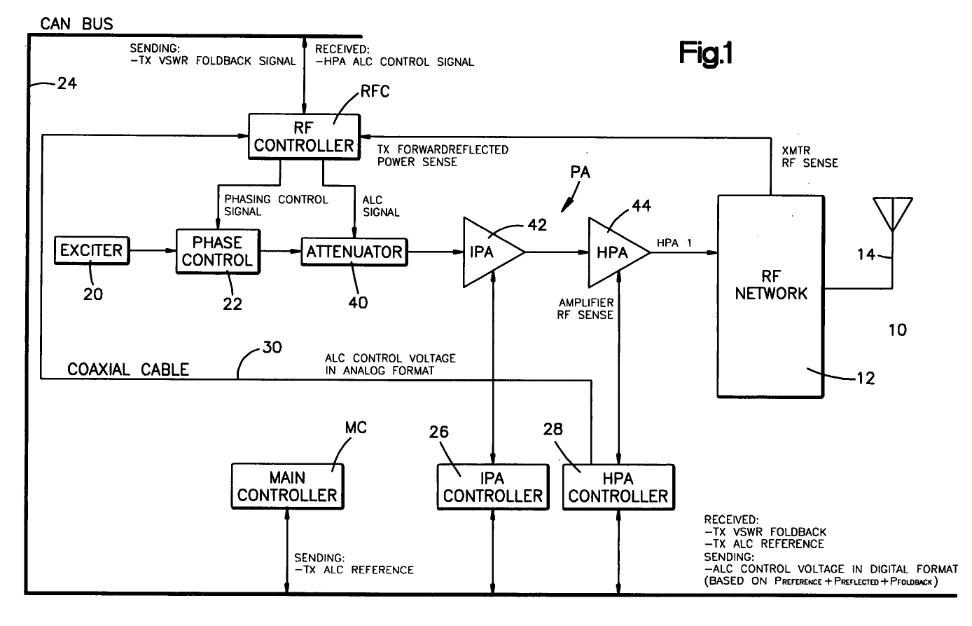

FIG. 1 is a schematic-block diagram of one embodiment of the present invention;

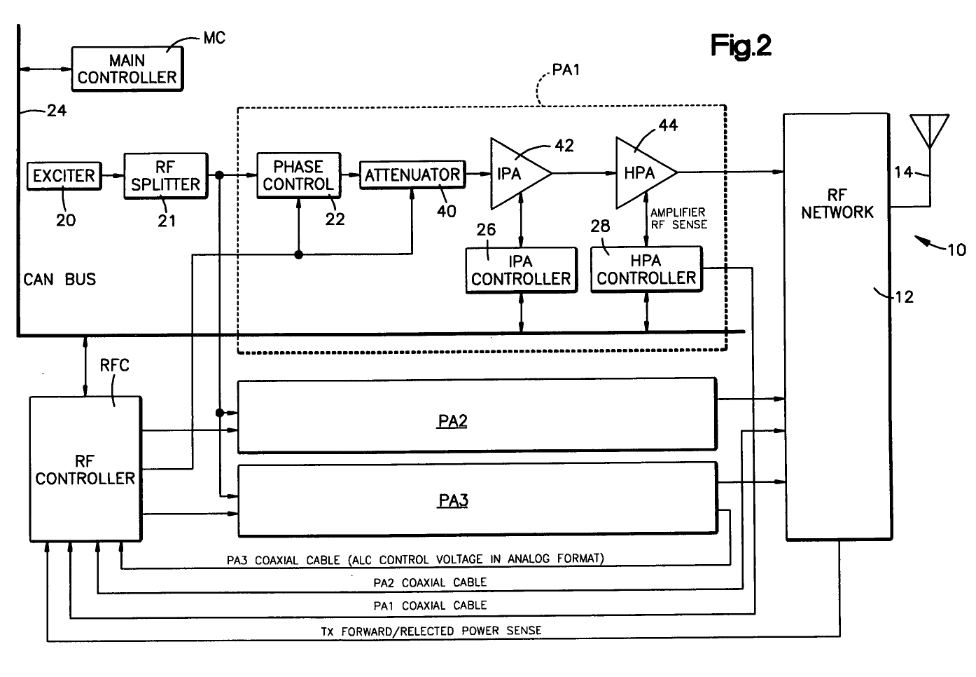

FIG. 2 is a schematic-block diagram illustration similar to that of FIG. 1 but illustrating a plurality of power amplifiers;

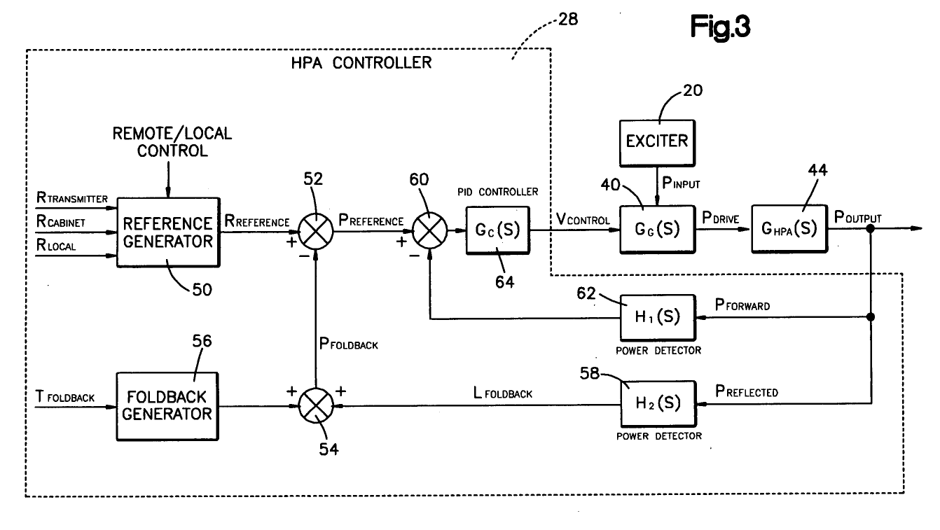

FIG. 3 is a block diagram illustration directed to the amplifier controller of FIGS. 1 and 2; and

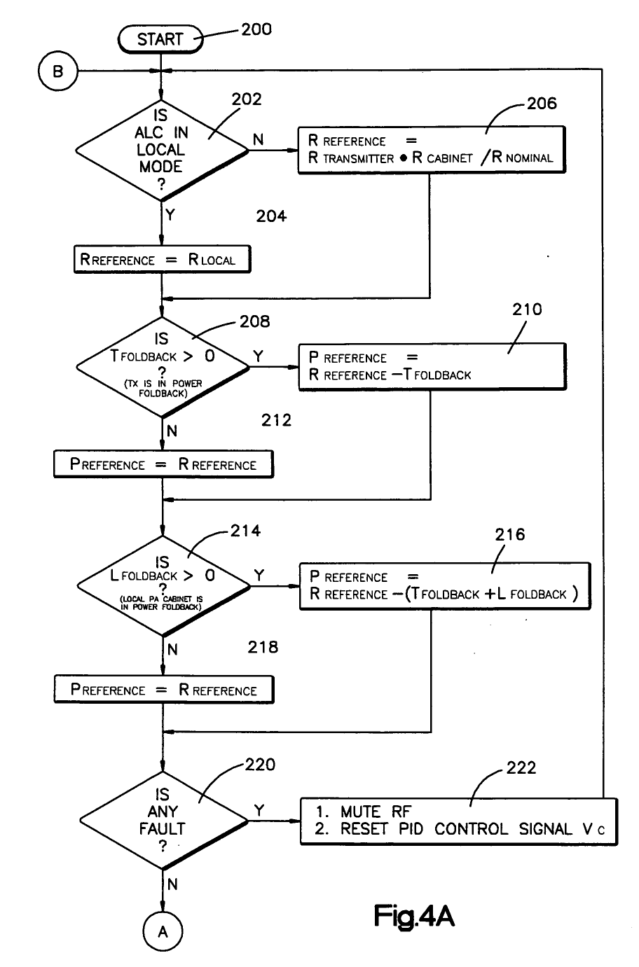

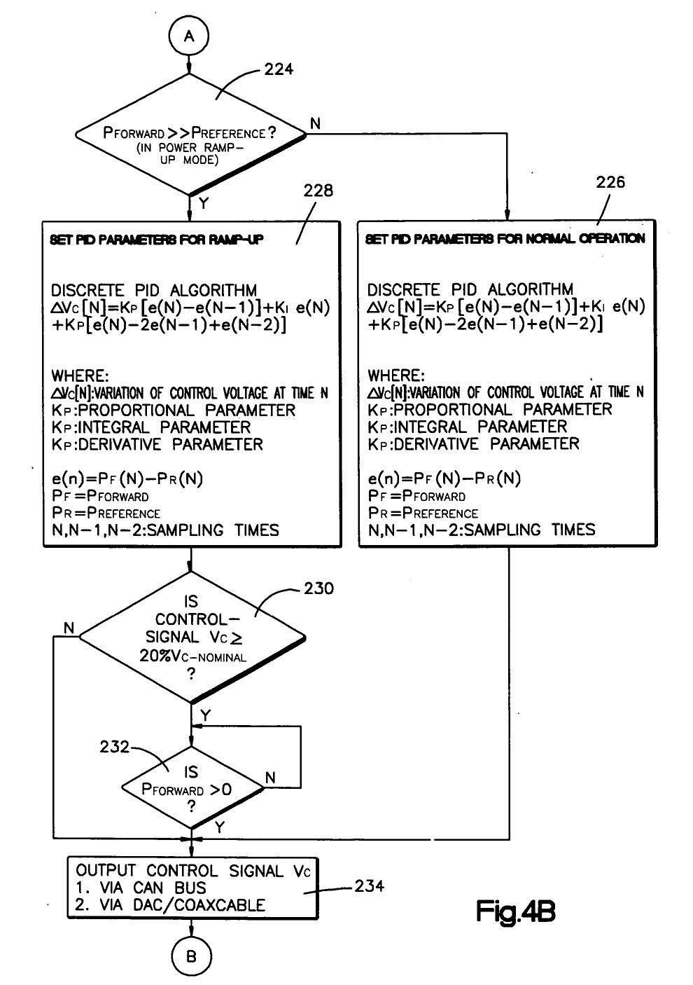

FIG. 4a and FIG. 4b together comprise FIG. 4 which illustrates a flowchart of the ALC operation.

### DESCRIPTION OF THE PREFERRED EMBODIMENT OF THE PRESENT INVENTION

The power amplifier system of FIGS. 1 and 2 includes a power amplifier or called high power amplifier (HPA) to supply an output RF power signal to an output circuit 10 which may include an RF network 12 and a transmitting antenna 14. The power amplifier receives an input signal from a suitable source such as an exciter 20 which supplies a signal to an RF splitter 21 to split the RF signal then the splitted RF signal will be applied to phase control 22 for each PA block or PA cabinet PA that receives a phasing control signal from an RF controller (RFC). The phase control signal is set by the user to control the amount of phase shift that will be applied to the incoming signal from the exciter.

The power amplifier of FIG. 1 also includes an attenuator that adjusts the exciter's phase shifted signal in accordance with a control signal, known as the ALC signal, obtained from the RF controller RFC. This signal is based on information received from the CAN bus 24 or coaxial cable 30. This information is sent to by the HPA controller 28 to the RF controller RFC. The RF controller receives an HPA-ALC control signal by way of a control area network communication bus (CAN bus) 24. The RF controller (RFC) is in communication through the CAN bus, with a main controller (MC), with an intermediate power amplifier (IPA) controller 26 and a high power amplifier (HPA) controller 28. The HPA controller 28 provides an HPA-ALC control voltage in a digital format to the CAN bus 24. This adjusts the attenuator 40 to control the attenuation of the signal obtained from the exciter prior to being amplified by the intermediate power amplifier 42 and thereafter by a high power amplifier 44.

With reference to FIGS. 1 and 2, the traffic on the CAN bus 24 is reviewed as follows. With respect to the HPA controller 28, it receives from the CAN bus the TX-VSWR foldback, from the RF controller (RFC), and the TX-ALC reference signals, from the main controller (MC). This controller sends out to the bus, the HPA-ALC control voltage in digital format (based on T_{REFERENCE} plus T_{REFLECTED} plus T_{FORWARD} to be discussed in greater detail hereinafter), which will be received by the RF controller RFC.

The signal flow discussed above with reference to FIG. 1 is also illustrated in FIG. 3 to which attention is now directed. FIG. 3 illustrates the signal flow of the amplifier controller 28. The controller includes a reference generator 50 that receives signals including an R_{TRANSMITTER}, an R_{CABINET} and an R_{LOCAL}, together with a remote-local control. This reference generator then provides to the positive input of a mixer 52 an R reference. The mixer 52 also receives at its negative input a P_{FOLDBACK} from a mixer 54 that receives a signal from the output of a P_{OUTPUT} foldback generator 56 that, in turn, receives a T_{FOLDBACK} input. The mixer 54 also receives an L_{FOLDBACK} from a power detector H(s), serving as detector 58 that, in turn, receives a P_{REFLECTED} signal from the output P_{OUTPUT}. The output from the mixer 52 is a P reference and this is supplied to the positive input of a mixer 60 that receives a signal from a power detector 62 H(s). This power detector receives a P_{FORWARD} signal from the output P_{OUTPUT}. The output of the mixer 60 is supplied to a PID controller 64 (G_{c}(s)). The output of controller 64 is applied to the attenuator 40 that receives a signal from the exciter 20. The output of the attenuator 40 is supplied to the power amplifier 44 G_{HPA} (S)

Having briefly described FIGS. 1-3, reference is made to the following discussion which presents further definitions of the reference signals in the local and remote modes followed by a plurality of definitions, all of which are helpful in understanding the operation.

Where:

AT local mode:

R_{REFERENCE}=R_{LOCAL} (local Reference)
   At remote mode:
R_{REFERENCE}=R_{TRANSMITTER}·R_{CABINET}/R_{NOMINAL}
   And,
P_{REFERENCE}=R_{REFERENCE}−P_{FOLDBACK}
P_{FOLDBACK}=T_{FOLDBACK}+L_{FOLDBACK}
   Definitions:
R_{REFERENCE}: The power level reference generated from the power level reference setting of either R_{LOCAL}, or R_{TRANSMITTER} and R_{CABINET} combined.
R_{LOCAL}: The power level reference set at the local HPA while it is in local mode.
R_{TRANSMITTER}: The power level reference set in transmitter level.
R_{CABINET}: The power level reference set at the local HPA while it is in remote mode.
R_{NOMINAL}: The power level reference related to high power amplifier's nominal output power (100% power).
P_{REFERENCE}: The actual power reference after power adding the power foldback compensations.
P_{FOLDBACK}: The power reduction (foldback) level generated from the transmitter/system level foldback and the local HPA foldback.
T_{FOLDBACK}: The transmitter/system level power foldback.
L_{FOLDBACK}: The local HPA power foldback.

FIG. 3 is a block diagram of the ALC scheme, which describes the system from the signal flowing or input/output view point. On the left side of the block diagram there are input signals to the system, which include R_{TRANSMITTER}, R^{cabinet}, R_{LOCAL}, T_{FOLDBACK}, and Local/Remote control signal. On the right side, there is an output signal P_{OUTPUT} or P_{FORWARD}. Each block describes a subsystem or a component in input/output view point. In other words, each block is the transfer function or mathematic modeling of the subsystem.

The System Transfer Function (Not Including Power Reference/Foldback)
G(S)=P_{FORWARD}|P_{reference}=G_{C}(S)·G_{HPA}(S)/[1+(G_{C}(S)·G_{G}(S)·G_{HPA}(S)·H₁(S))] Equation 1:
Or,
P_{FORWARD}=G_{C}(S)·G_{G}(S)·G_{HPA}(S)/[1+(G_{C}(S)·G_{G}(S)·G_{HPA}(S)·H₁(S)]·P_{REFERENCE} Equation 2:
Here,
P_{FORWARD}: Transmitter forward output power
G_{C}(S): PID control transfer function
G_{G}(S): The transfer function for input RF path, including attenuator and IPA
G_{HPA}(S): The transfer function of transfer function
H₁(S): The transfer function of RF detector for forward power
   The Discrete PID Algorithm
   ΔV_{C}[N]=Kₚ[e(N)−e(N−1)]+K₁e(N)+K_{D}[e(N)−2e(N−1)+e(N−2)] Equation 3:
   Where:
ΔV_{C}[N]: Variation of Control Voltage V_{C}[N] at Time N
V_{C[N]: The control voltage applied to the system gain control attenuator at Time N.}
K_{P}: Proportional Parameter
K_{P}: Integral Parameter
K_{P}: Derivative Parameter
   e(n)=P_{F}(N)−P_{R}(N)
P_{F}=P_{FORWARD} (Forward Power)
P_{R}=P_{REFERENCE} (Power Reference)
N, N−1, N−2: Sampling Time
The VSWR Algorithm

$$Equation 4 \text{:} \\ VSWR = \frac{1 + \sqrt{{P}_{r} / {P}_{f}}}{1 - \sqrt{{P}_{r} / {P}_{f}}}$$

General VSWR Power Foldback Algorithm
T_{FOLDBACK}=f(VSWR_{T}, P_{Reflected}_{_{—}}_{TX}) Equation 5:
L_{FOLDBACK}=g(VSWR_{L}, P_{Reflected}_{_{—}}_{Local}) Equation 6:
Here functions f( ) and g( ) could be any algorithms.
Where:
P_{Reflected}_{_{—}}_{TX}: Transmitter reflected power
P_{Reflected}_{_{—}}_{Local}: Local PA reflected power
VSWR_{T}: Given transmitter VSWR
   The foldback functions f(VSWR_{T}, P_{Reflected}_{_{—}}_{TX}) and f(VSWR_{T}, P_{Reflected}_{_{—}}_{TX}) f(VSWR_{T}, P_{Reflected}_{_{—}}_{TX}) f(VSWR_{T}, P_{Reflected}_{_{—}}_{TX}) are given a relationship between the power reduction level T_{FOLDBACK} or L_{FOLDBACK}, and given VSWR setting and actual reflected power. It describes how the power reduction level is associated with VSWR setting and the real reflected power at the any given time.
   Flowcharts of ALC Operation

Reference is now made to FIGS. 4A and 4B which illustrate the flowchart of ALC operations. The operation commences at step 200 and then advances to step 202 during which a determination is made as to whether the ALC is in a local mode. If it is, the procedure advances to step 204 at which R_{REFERENCE} is set as being equal to R_{LOCAL}. If not, the procedure advances to step 206 at which R_{REFERENCE} is set equal to the product of R_{TRANSMITTER} times the ratio of R_{CABINET} to R_{NOMINAL}. The procedure then advances to step 208 at which a determination is made as to whether T_{FOLDBACK} is greater than “zero”. If “yes”, then the procedure advances to step 210 at which P_{REFERENCE} is made to R_{REFERENCE}−T_{FOLDBACK}. If the decision is “no” in step 208, then procedure advances to step 212 during which P_{REFERENCE} is set equal to R_{REFERENCE}.

The procedure then advances to step 214 and a determination is made as to whether L_{FOLDBACK} is greater than 0. If the determination is “yes”, the procedure advances to step 216 at which P_{REFERENCE} is equal to R_{REFERENCE}−(T_{FOLDBACK}+L_{FOLDBACK}). If the determination at step 214 is negative, the procedure advances to step 218 at which P_{REFERENCE} is made equal to R_{REFERENCE}. The procedure then advances to step 220 at which a determination is made as to whether there is any fault. If “yes”, then the procedure advances to step 222 during which the RF is muted and the PID control signal V_{c} is reset.

If the determination at step 220 is negative, then the procedure advances to step 224 (see FIG. 4B). In step 224, a determination is made as to whether P_{FORWARD} is (perhaps significantly greater) than P_{REFERENCE}. If not, the procedure advances to step 226 at which the PID parameters are set for normal operation in the manner as indicated in block 226.

If the determination in step 224 is “yes”, then the PID parameters are set for ramp up in the manner as set forth in the block of step 228. Upon completion of step 228 the procedure advances to step 230 during which a determination is made whether the control signal V_{c} is equal to or greater than 20% V_{c-NOMINAL} (no-power threshold). If “yes”, the procedure advanced to step 232 during which a determination is made as to whether P_{FORWARD} it is greater than 0. If not, the procedure step 232 repeats itself. If the determination in step 232 is “yes”, then the procedure advances to step 234 during which control signal V_{c} is presented by way of the CAN bus 224 the coaxial cable 30.

### ISSUE DISCUSSION

Having now completed the description of the control scheme herein, reference is made to the following discussion which is addressed to providing answers to the issues presented herein at an earlier stage in this description. These are the issues 1-6.

The first issue is resolved by using a reliable CAN (Control Area Network) communication bus, or any other serial communication bus, to pass the control signals as well as all other system, sub-system information. The digital communication bus to pass the control signal is noise-free after error checking. The CAN bus has 250 kHz data rate, which guarantees that the transmission time of the control data is negligible. In order to increase the reliability of the ALC system, a redundant analog ALC circuit is designed into the ALC scheme. In the normal operation mode, the digitized control signal, generated by HPA controller, will be sent to the gain control device (RF controller) via the CAN bus, and at the same time an analog signal generated with the control signal through a DAC device in the HPA controller will be sent via a separate coaxial cable, but later will not be used during normal operation. During a CAN bus failed condition, a software bus traffic-monitoring timeout will signal the bus traffic failure condition. Thus, an analog switch will switch the digital control signal path to analog control signal path to automatically maintain the ALC in operation.

For the issue of IPA power sudden loss (the second issue), which causes the drive power loss, as well as output power loss, the controller monitors the output power and once it detects output power sudden loss, it will mute the sub RF system and wait for a short time and then ramp up its control voltage to a predetermined level; say about 20% value of the correspondent to the nominal output power. If the drive power comes back, the 20% of the nominal control voltage will generate about 20% of output power. If so, the HPA controller will ramp up the ALC signal or control voltage as a normal ramp up operation, otherwise the control voltage generated by the HPA controller will be no more than 20% of its nominal value until the drive power recovers. For the issue of the IPA fault at the beginning of the power ramp up, since there is no way to detect the drive power loss condition for the discussed power amplification system until the power ramps up, the HPA controller will ramp up the control voltage to 20% value corresponding to 20% of the nominal output. If the output has not come up, the control voltage will stay at 20% until the output power, which will be proportional to the drive power, comes up. At either case of the IPA recovering from the fault or condition like the drive power link, disconnected then reconnected, the HPA controller will prevent the over drive and output power overload condition happens.

For the issue of the flexible and intelligent power ramping up process (the third issue), the ALC in the HPA controller is based on the reference to the output power, the predetermined ramping time to realize the ramping up slope and the steps, no matter what the power reference level is, the ramping up has the same time. The ALC could be programmed with multi-slope if needed in some other cases.

For the issue of the multi-references for remote and local control mode (the fourth issue), the scheme has the separate references for its remote mode and the reference for local mode. The remote mode has transmitter reference and cabinet reference; the transmitter reference is controlled at the transmitter while the cabinet reference is controlled at the cabinet. Either of them can fully raise or lower the output power of the individual cabinet. The local ALC reference is used when the cabinet is in local mode. At the local mode, the cabinet power will not be controlled from transmitter level, it only determined by the local ALC reference setting, which has no any direct relation with the remote transmitter or cabinet reference.

The digital PID controller (the fifth issue) in the digital ALC scheme has the flexibility to manipulate the PID parameters based on the system operational condition. In this case, two sets of the PID parameters K_{P}, K_{I}, and K_{D} are used, one is for power ramp-up, dynamic stage; and another set is for normal operation, steady stage. The PID parameters K_{P}, K_{I} and K_{D} used in dynamic stage are designed to optimize the fast time response without any power overshoot. The PID parameters K_{P}, K_{I}, and K_{D} used in steady state are designed to minimize the steady state error.

The digital ALC (the sixth issue) will have flexibility to implement the complicated VSWR foldback algorithm. For the multi-source power foldback, the amplifier controller will use the foldback signal generated by the transmitter level controller and the foldback signal generated by the amplifier controller, to modify its summarized power reference to generate a final output power reference.

### SUMMATION

The invention includes the following advantages:
1. There is no distance limitation (in hundreds of meters) between control device and the device to be controlled since the wire length will not affect the quality of the control voltage signal communicated in digital format. The control signal is noise free during the signal transmission, this improves the system performance to have much stable and accurate gain control, as well as output power.
2. The digital ALC scheme has the characteristics, which the conventional ALC does not have. The intelligence of the digital ALC avoids the overdrive and the power overload at complicated operational condition to increase the transmitter stability and prolong the amplifier's life, in this case the MSDC tube's lifespan.
3. The digital ALC scheme in the system could have multi power references to have maximum flexibility to have amplifier generate the desired power output.
4. The digital PID algorithm has two sets of the parameters of K_{P}, K_{I}, and K_{D}. One set is used for ramp-up stage, and another set is used for steady state—normal operation. This greatly eases the difficulty of the PID controller's tuning and design.
5. The ALC scheme has flexibility to implement complex power reduction algorithm. It could implement the multi-foldback mechanism, which could be based on the different foldback resources.

Although the foregoing has been described in conjunction with a preferred embodiment, it is to be appreciated that various modifications may be made without departing from the spirit and scope of the invention as defined by the appended claims.

Having described the invention, we claim the following:

1. A digital power level control for an RF broadcast transmitter, comprising:
an RF high power amplifier that receives an RF signal from an exciter and provides therefrom an amplified RF output;
an adjustable attenuator interposed between said exciter and said power amplifier for adjusting the level of said RF signal;
an RF controller that adjusts said attenuator;
a high power amplifier controller that generates a power level control signal to control the high power amplifier output power; and
a communication bus that connects all the controllers and to allow control signals to be transmitted and received by these controllers.

2. A control as set forth in claim 1, including an intermediate power amplifier, intermediate said attenuator and said high power amplifier.

3. A control as set forth in claim 2, including an intermediate power controller that controls said intermediate power amplifier.

4. A control as set forth in claim 3, wherein said bus interconnects said main controller and said intermediate controller.

5. A control as set forth in claim 4, wherein said bus interconnects said main controller and said RF controller.

6. A control as set forth in claim 5, wherein said bus interconnects said RF controller and said intermediate controller.

7. A control as set forth in claim 6, wherein said bus interconnects said RF controller and said high power amplifier controller.

8. A control as set forth in claim 7, wherein said bus interconnects said RF controller and said main controller and said intermediate power amplifier controller and said high power amplifier controller.

9. A control as set forth in claim 8, wherein said bus interconnects said main controller and said RF controller with a plurality of power amplifier systems each including a said attenuator, a said high power amplifier and a said high power amplifier controller.

10. A control as set forth in claim 9, wherein each said power amplifier system also includes a said intermediate power amplifier and an intermediate power amplifier controller.

11. A control as set forth in claim 10, including a single set exciter and RF splitter for supplying therefrom an RF signal to each of said power amplifier systems.
